(19) United States
(12) Patent Application Publication
(10) Pub. No.: US 2002/0099639 A1
(43) Pub. Date: Jul. 25, 2002

(54) Method and apparatus for electronic business postings and negotiated transactions

(76) Inventors: Michael James Caughey, Richmond, VA (US); Tamara Olga Petroff, San Pedro, CA (US); Brandon Curiel, Hamden, CT (US)

Correspondence Address: PATTON BOGGS LLP, 2550 M STREET, N. W., WASHINGTON, DC, 20037, US

(21) Appl. No.: 09/765,039

(22) Filed: Jan. 19, 2001

(51) Int. Cl. G06F 17/60

(52) U.S. Cl. 705/37

(57) ABSTRACT

An electronic business posting and negotiated transaction system for offering business products and inventory for sale, receiving offers and counter-offers to buy, and conducting transactions for the same. The system utilizes a web-based relational database which receives, qualifies, and stores postings of business products, and receives, qualifies and responds to search queries for postings. The system receives, qualifies and transmits offers for purchase to sellers, transmits counter-offers, and maintains a searchable record of the communications and of the status of the posted goods.

### DESCRIPTION

1. Field of the Invention

This invention relates generally to the field of electronic business posting and negotiated transaction and, more particularly, to a method and apparatus for offering business products and inventory for sale, receiving offers and counter-offers to buy, and conducting transactions for the same.

2. Description of the Related Art

Ongoing businesses frequently find themselves possessing excess inventory, excess capacity, and idle assets which, if they could be converted into liquid value in an efficient manner, could be properly utilized for the benefit of the business. In addition, when failing businesses begin to wind down, or suddenly collapse, interested parties such as creditors frequently find themselves in possession of hard inventory and specialized business equipment having no immediate value to them, but which could certainly be applied to outstanding debts, if that inventory and idle equipment could be converted to cash. The present inventors have identified estimates of the current worldwide market of such excess assets and inventory, termed “the Surplus Marketplace”, of about one trillion dollars. There is not any known standardized, large scale integrated system for general marketing within the Surplus Marketplace. Instead, various niche trades, businesses and operations, including traditional auction companies, liquidators and close-out dealers, have developed to fill the needs of the market. Some of these have migrated, in parts anyway, to the Internet, as “born-on-web” e-tailers, auctions and so called “electronic marketplaces”. Even further, a number of barter companies have appeared.

The presently existing market means and business methods for marketing, offering and selling excess and surplus inventory, however, have a number of shortcomings, both from the sellers' and the buyers' perspective. From the buyers' perspective, the shortcomings include lack of information about the seller, including the names of contacts, incomplete description of the goods, incomplete description of the terms and conditions of sale, including payment terms and shipping arrangements. Other shortcomings from the buyers' perspective include: limited geographical range for which the buyer is made aware of sellers' offerings, insufficient means to communicate counter-offers back to the seller, and lack of a practical independent verification of the seller, and lack. From the sellers' perspective the shortcomings include: inability to economically screen buyers, insufficient provisions for negotiating counter-offers with the buyers, insufficient geographical reach of the sellers' offerings, and lack of trusted entities for handling the actual transactions.

### SUMMARY OF THE INVENTION

An object of the present invention is to solve the above-identified shortcomings with the existing means and business methods for marketing, offering, and selling excess inventory, and surplus goods and equipment and other idle assets.

A general method according to the present invention establishes relational database of offer date records representing registered users, inventory listings by registered users, offers or purchase orders from registered buyers, and the content and activity of business accounts for the users. The method establishes the relational database by receiving a plurality of data records, each having a descriptor data field identifying a commodity and an identify of an offeror. The database then stores the plurality of offer data records. A status flag for each of the plurality of offer data records, indicating whether the inventory listing is for sale, sold, withdrawn, or pending authorization is initializing to a first state. Next the method receives at the database an inquiry from a buyer computer remote from the database, the inquiry having a search field corresponding to at least a portion of the descriptor data field. The database then selects one or more of the offer data records from said database based on the inquiry search field. Next, the database transmits the selected one or more offer data records, and the status flag associated with the each of the selected one or more data records, to the buyer computer. The database then receives a purchase order data record from the buyer computer. The purchase order data record identifies a buyer and a particular offer data record from the one or more selected offer data records, and has a purchase offer field identifying one or more terms of an offer for purchase of the commodity identified by the descriptor field of the particular offer data record. The database then stores the purchase order data record and transmits a purchase order received data to the offeror identified by the descriptor field of the particular offer data record. The purchase order received data identifies the buyer, identifies an offer of sale corresponding to the particular offer data record, and identifies the one or terms of an offer for purchase. Next, the database receives a seller response data from the offeror, the seller response data having an acceptance field reflecting acceptance of, rejection of, or a counter-offer to the one or more terms of an offer for purchase. The database stores the seller response data and transmits to the buyer a seller response received data, the seller response received data identifying contents of the acceptance field of the seller response data. The database then receives a committed purchase order data from the buyer and changes to a second state the status flag data associated with the particular offer data record.

### BRIEF DESCRIPTION OF THE DRAWINGS

The foregoing and other objects, aspects, and advantages will be better understood from the following description of preferred embodiments of the invention with reference to the drawings, in which:

FIG. 1 is a system architecture diagram of a an example system according to the present invention;

FIG. 2 is a general system functional block diagram and flow chart for operation of a method according to the invention;

FIG. 3 is an example screen arrangement for showing user activity of the FIG. 1 system and FIG. 2 method

FIG. 4 is an example screen arrangement for showing an account search summary at a step of a method in accordance with FIG. 2;

FIG. 5 is an example screen arrangement for displaying an account search summary according to FIG. 4, for a search for a first status of offered inventory, orders and accounts;

FIG. 6 is an example screen arrangement for displaying account details of an account indicated by a search summary in accordance with FIG. 4;

FIG. 7 is an example screen arrangement for displaying current offers for purchase on a selected inventory posting shown by the account details according to FIG. 6;

FIG. 8 is an example screen arrangement for displaying a record of offers and counter-offers between users for a selected inventory posting shown by the account details according to FIG. 6; and

FIG. 9 is an example of a display of a comment field associated with a record of offers and counter-offers according to FIG. 8.

### DETAILED DESCRIPTION OF THE INVENTION

Provisional Application Serial No. 60/176,127, filed Jan. 14, 2001, on which the present applicant bases priority, is hereby incorporated by reference.

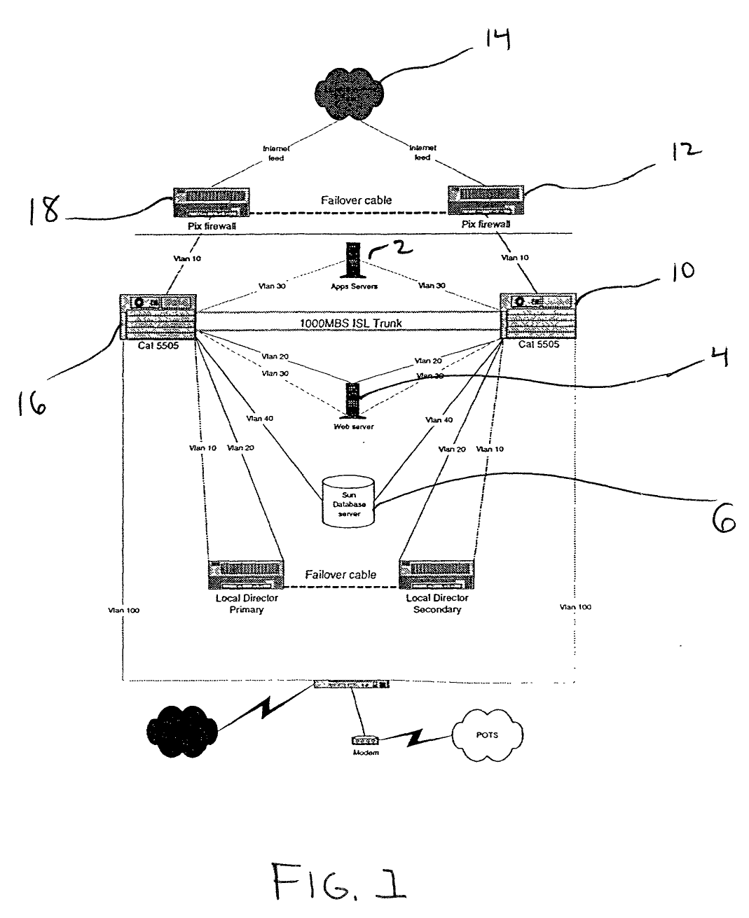

FIG. 1 herein shows an example system diagram for implementing a method according to this invention. The FIG. 1 system includes a site 1 having a front tier 2, a middle tier 4, and a back tier/storage system 6. The front tier 2 comprises the web server hardware and software which provides end-users, which will be described below, with access to the site 1. The middle tier 4 comprises the application server and hardware and software which provides the business logic for carrying out the operations described below. The back tier/storage system 6 comprises the database server and software. The back tier/storage system 6 provides persistent storage of records of site activity, including records received from users and audit logs, as described below.

An example hardware and operating system for the front tier 2 consists of two Sun E250s web servers (not shown), or equivalents, each running Solaris 2.6, and each configured with a single 400 MHz CPU (not shown) with 512 MB of RAM. Example software for carrying out the server operations is Netscape Enterprise Server, or equivalent. The use of two web servers is a design choice based on a balancing of reliability and cost, using criteria well known to one of ordinary skill in the art. A single web server could be used, but with a concomitant reduction in reliability. If two web servers are used then a load balancing subsystem (not shown) should be included, as known to one of ordinary skill. An example of load balancing subsystem comprises a Cisco Local Director (not shown), which provides load balancing and automatic failover between the two web servers.

An example hardware and operating system for the middle tier 4 consists of two Sun E450s servers (not shown), or equivalents, each running Solaris 2.6, and each configured with a single 400 MHz CPU (not shown) with 1 GB of RAM. Example software for carrying out the server operations of the middle tier 4 is BEA WebLogic, preferably with clustering. The clustering feature with the BEA WebLogic is not a necessity but better utilizes the fault tolerance obtained with two servers. The use of two servers in the middle tier 4 is a design choice based on a balancing of reliability and cost, using criteria well known to one of ordinary skill in the art. A single web server could be used, but with a concomitant reduction in reliability.

An example hardware and operating system for the back tier section (not shown) of the back tier/storage system 8 consists of a primary server (not shown) and a secondary server (not shown). An example primary server is a Sun® E3500, with four 400 MHz CPUs, and 1 GB of RAM. An example secondary server is a Sun® E450, with four 400 MHz CPUs and 1 GB of RAM. Example software for carrying out the back tier operations, which are described below, performed by the back tier/storage system 8 is Oracle® 8i Enterprise Edition, Veritas® Database Edition for Oracle with Veritas® Cluster Server.

An example hardware and operating system for the storage section (not shown) of the back tier/storage system 8 consists of a Clariion® 5310 full-fiber channel RAID (Redundant Array of Independent Disks), storage array with six 9 GB drives, for a total storage capacity of 54 GB. Example storage management software is the Clariion® Navisphere™ manager.

The above-described example hardware and software for each of the front tier 2, the middle tier 4 and the back tier/storage system 6 is for purposes of example only. Other alternative commercially available hardware and software could be readily identified and selected by one of ordinary skill in the art.

Referring to FIG. 1, the front tier 2 connects by a Vlan 30 or equivalent data connection (not numbered), to a first router 10 which connects to a first firewall 12. The first firewall 12 provides primary security and address translation and connects to the Internet 14. In a full redundancy and failover arrangement, the front tier 2 also connects by another Vlan 30 or equivalent data connection (not numbered), to a second router 16 which connects to a second firewall 18. The second firewall 18 connects to the Internet 14.

Example implementation of the first and second firewall 12 and 18 is a Pix™ 520 unit. Example hardware for the first and second routers 10 and 16 is a Catalyst 5505 with Gigabit Ethernet trunking and Rout Switch Failure Card (not shown).

Referring to FIG. 1, redundancy and load balancing between the first and second firewalls 12 and 18, and associated first and second routers 10 and 16, is provided by a first and second load balancing unit, labeled 20 and 22, respectively. Example commercially available load balancing units 20 and 22 include the Local Director™ unit.

As shown in FIG. 1, a plurality of users 24 connect to the Internet 14, each user having a standard personal computer (not shown), such as, for example, a Dell® Optiplex GX1, having a 300 MHz CPU, running under a Windows NT or Windows 2000 operating system, and having a web browser such as Netscape® Communicator or Windows Internet Explorer.

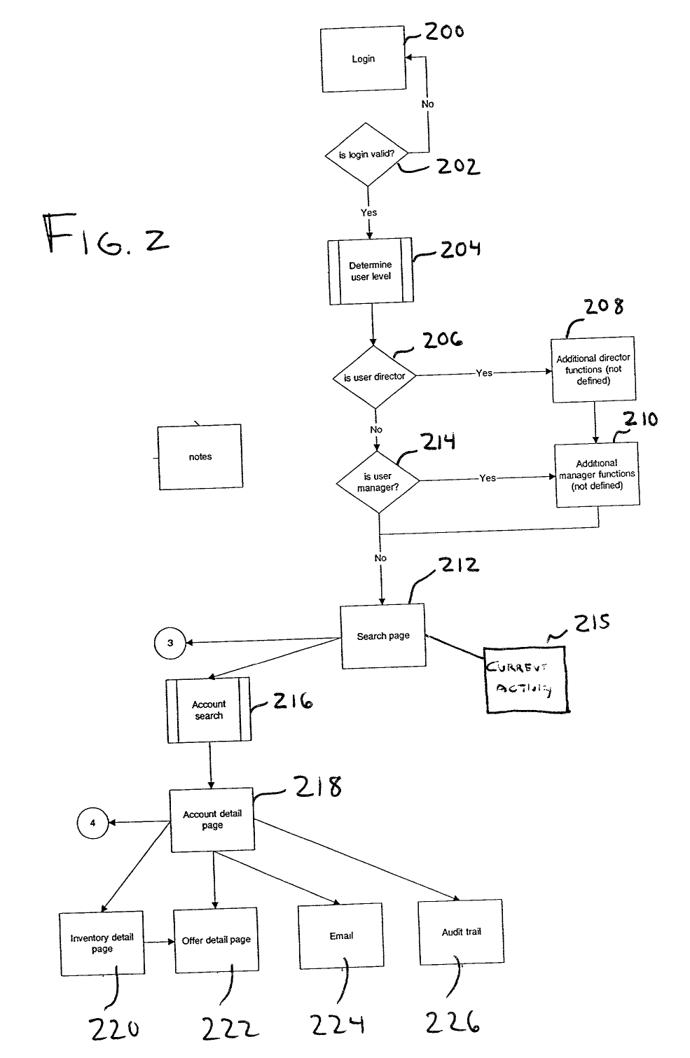

Referring to FIG. 2 an example operation of the posting and business transaction method of the invention will be described.

First, at block 200 a user 24 of FIG. 1, using a standard personal computer, as identified above, visits the system web site hosted by the site 1, using a standard web browser, such as Netscape Communicator. The user enters an employee ID and a password (not shown). Next, at step 202 the site 1 queries the database of the back tier 8 which, for this example, is an Oracle Enterprise, and determines if the login is valid. ID and password based login procedures are known in the art and, therefore, a description is not necessary for an understanding of this invention. If step 202 determines that the login is not valid the system returns the user to the home page of the web site. If step 202 determines that the login is valid the process goes to step 204 to identify the user level, based on the entered employee ID and password. The number of user levels is a design choice. For this example, three user levels are used: first level (which is the lowest order for access privileges), designating a user representative; second level, for user supervisors; and third level, which is for user directors (having the highest access privileges). To persons skilled in the general field of remote access databases, the schemes for limiting access to system data, enablement of editing capabilities for selected data, and access to system operations based on user level is a well known design feature and, accordingly, the specific method for carrying out such operations do not need description.

As shown at FIG. 2, if step 206 identifies the user as being level three, i.e. a user director, the process goes step 208 which defines additional functions to which that user has access. Since level three is the highest level, the process automatically goes to step 210 and provides the user with the functions accessible to the next higher user privilege, level two, and is then presented with a search page at step 212. If the answer at step 204 is “no” the process goes to step 214 to identify if the user has level two privileges. If the answer is “yes” the process goes to step 210, provides the user with privileges accorded level two, and presents the user the search page at step 212. As seen from FIG. 1, if the user has level one access privileges then he or she would pass, by a consecutive “no” at step 206 and 212, to the search page at step 212.

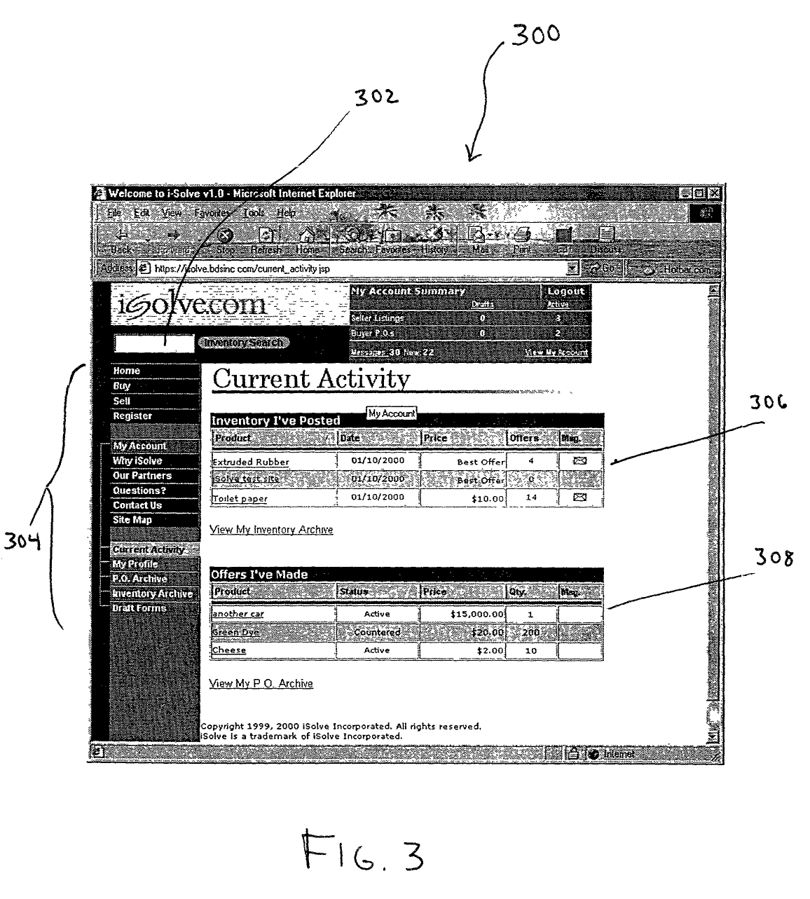

Referring to FIG. 3, an example search page 300 presented to the user at step 212 is shown. Field 302 is a search field and, at the left side of the screen is a plurality of click fields 304 for initiating labeled operations. One of the click fields within 304 is “Current Activity” 304a. The operation initiated by 304a queries certain activity logs, within the database of the back tier 8 of site 1, unlike the full search effected by clicking the “inventory search” button 302a. In response to the user clicking 304a the screen 300 displays “Inventory I've Posted”, at field 306, and “Offers I've Made”, at field 308. The example screen 300, based on the current activity shown, reflects a user who acts as both a seller and a buyer. Under “Offer's I've Made” 308 the example shows three account records (not numbered). Each account record contains a Status field, which is described in more detail below. A value of “active”, however, means that the seller has not accepted any offer for purchase of the product and, hence, the database within the back tier 8 has not updated the Status flag for that account record. A Status value of “countered” means that the seller posting the product has received a purchase order for the product, likely containing terms not acceptable to the seller, and that the seller has, accordingly, transmitted a counter-offer to the buyer, through the site 1.

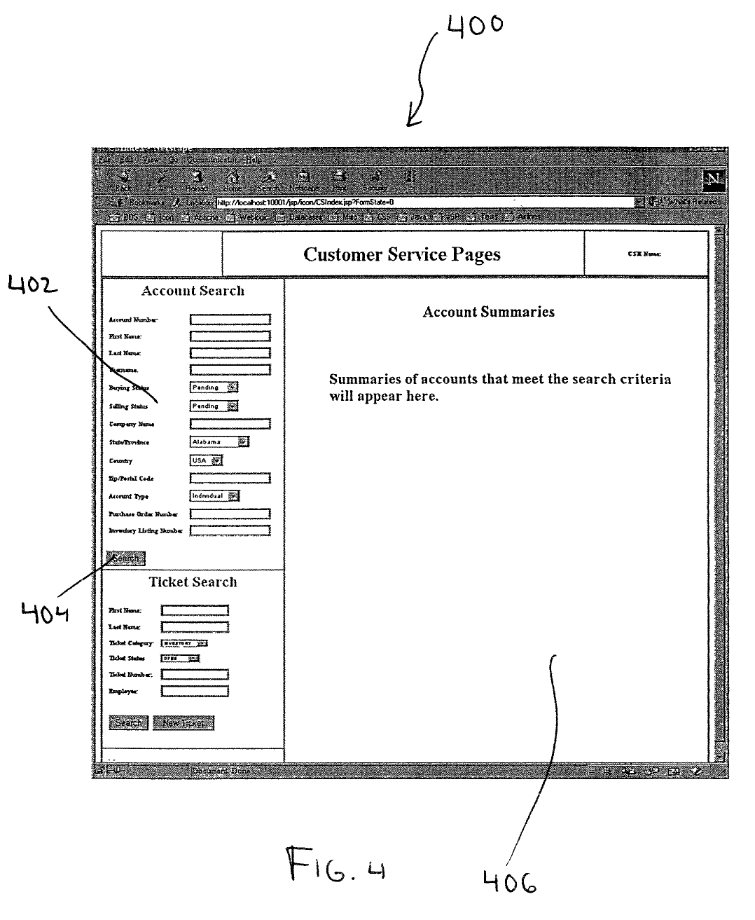

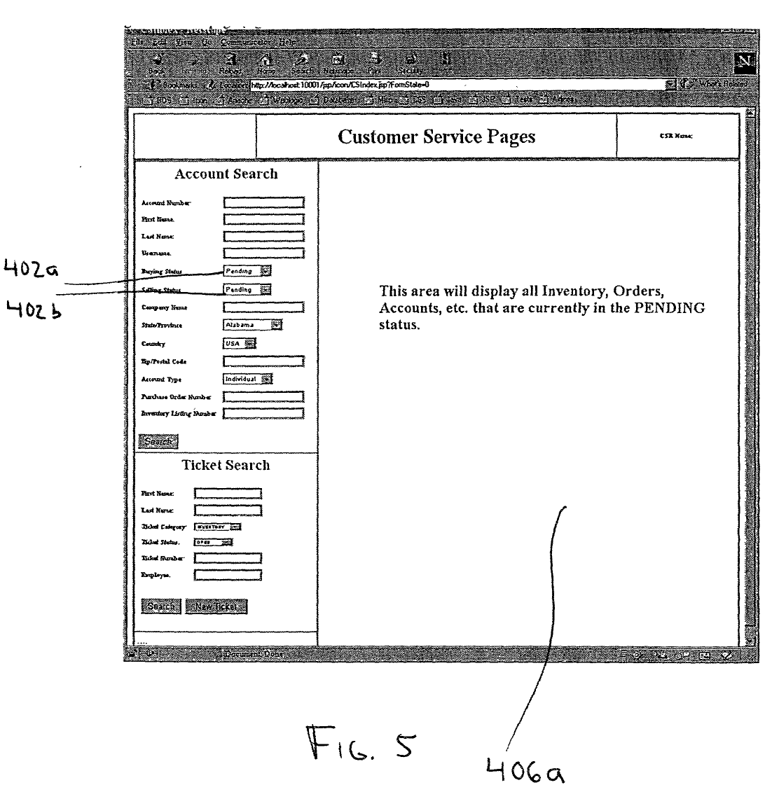

Referring to FIG. 4 an example screen shot 400 is depicted, showing what the user sees after initiating a search request through button 302a to the site 1. The search criteria are entered by the user into the appropriate fields 402. The user then clicks the “search” button 404 and the results, which are all accounts that meet the search criteria, are then obtained by the back tier 8 of site 1, transmitted to the user and displayed in field 406. Referring to FIG. 2, clicking the “search” button 304 moves the process to the search step 216. An example search is shown at FIG. 5, where the user entered into fields “buying status” and “'selling status” fields, labeled 402a and 402b, respectively, the value “pending”. In response, the back tier 8 of site 1 retrieved and transmitted all postings of goods, and offers for purchase of goods, that have a status flag of “pending”. As described in further detail below, a status value of “pending” means that the posting of the goods, or the purchase order for goods, has been received by site 1 but not validated for transmittal to the other users. Stated differently, a Status value of Pending means that approval for transmittal is pending. The validation feature and the associated Status value are not mandatory for inclusion in the system of the this invention, but are preferred.

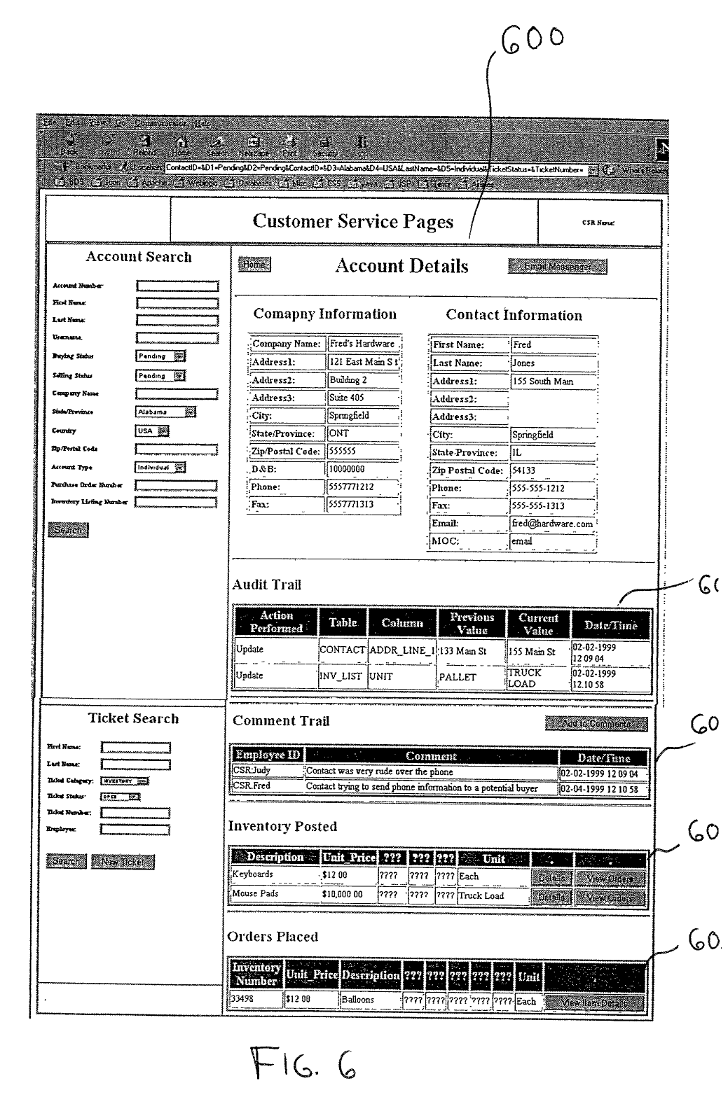

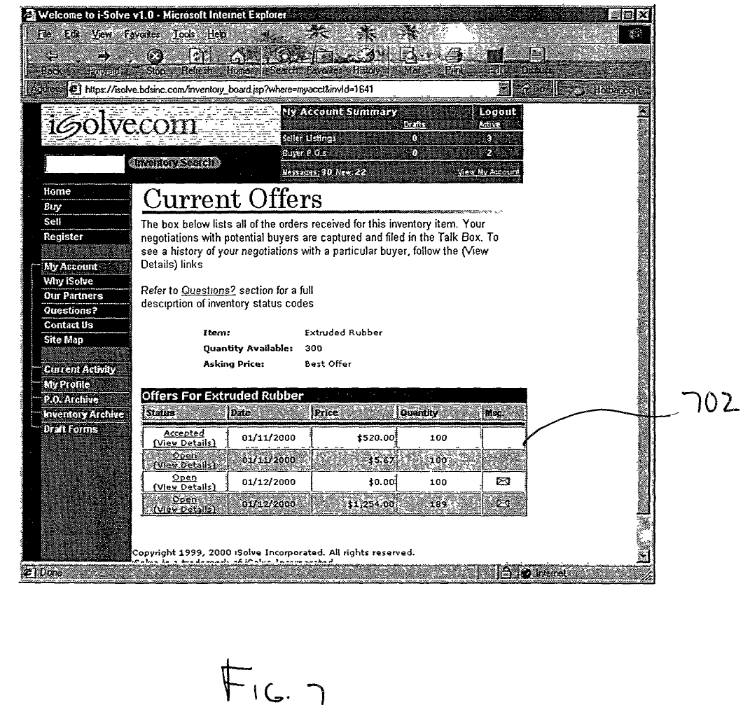

Referring to FIG. 2, after the search step at 216 the user can click on any of the retrieved accounts appearing in field 406 of FIG. 4, or on any of the accounts that appeared in the current activity fields 306 or 308 of FIG. 3. In response the process goes to the account detail page at step 218, and the site 1 rear tier 8 will retrieve the information shown at the Account Details screen 600 of FIG. 6. The details include, for example, the Audit Trail 602, Comment Trail 604, Inventory Posted 606, and Orders Placed 608. In addition, as shown at FIG. 7, the user can obtain particular information about a seller's posting such as current purchase orders 702, which are offers for purchase, received from buyers. As seen from FIG. 7, the described examples of this invention maintains anonymity of the buyers associated with each of the purchase orders 702.

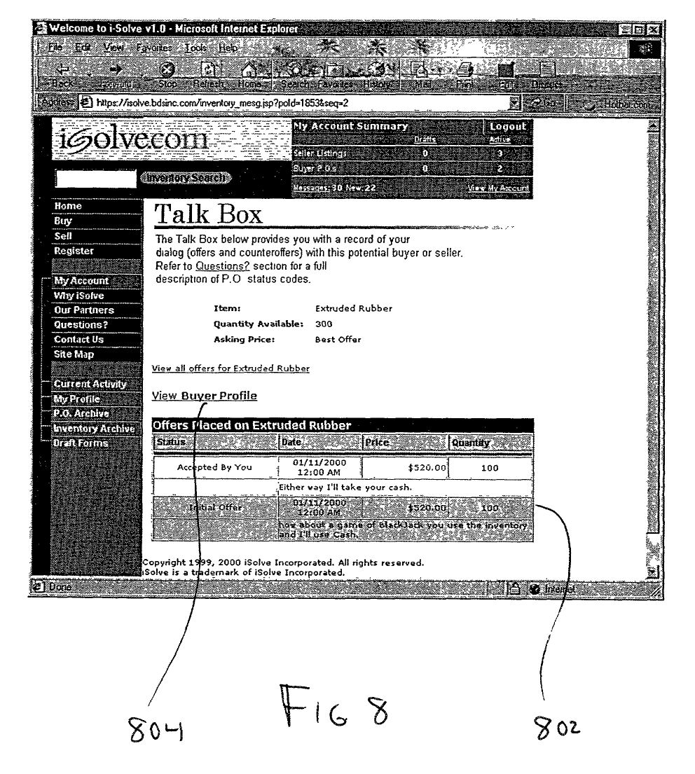

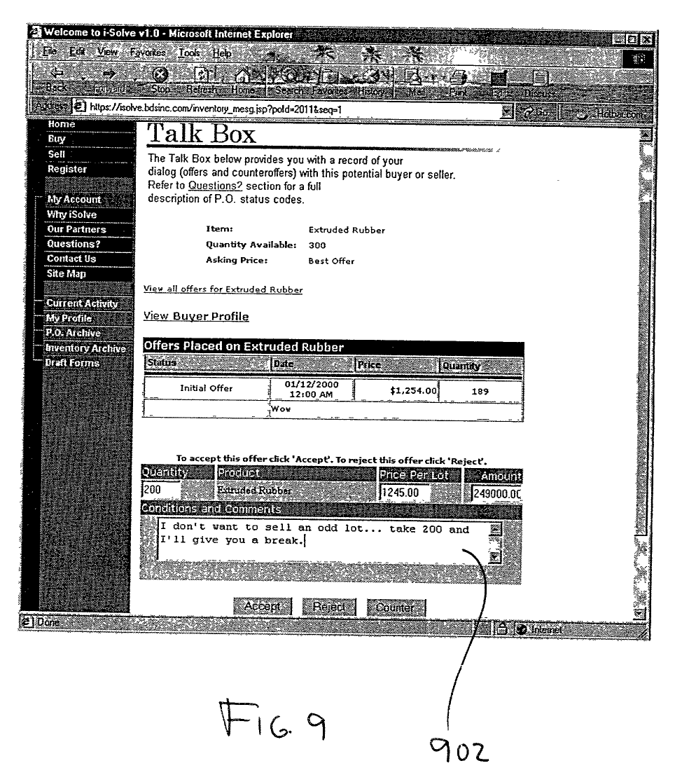

Referring to FIG. 2, when the user at step 218 is presented with the account detail page of FIG. 6, the user can click and obtain a Talk Box screen from the site 1 having, as shown at field 802 of FIG. 8, the record of the user's dialog, meaning offers and counteroffers, with the other user. In addition, the user can click at field 804 to obtain the profile of the other user. Referring to FIG. 9, the Talk Box can, at the user's choice, include the record 902 of the both the user's and the other user's comments associated with the offers and counteroffers.

Referring to FIG. 2, the user at step 218 has the further option, by clicking on the labeled fields in the browser display, of proceeding to step 220 and obtaining an editable page of all inventory fields of the user's offer for sale of a product. The user may also proceed to step 222 and obtain an editable page of details of the user's purchase order or offer to purchase. Further, the user can proceed to step 224 and obtain an e-mail page (not shown) having a drop down list box of all contacts for the selected account. the page also contains a drop down combination box for the subject of the e-mail. If the user selects on a predefined e-mail subject, the selection will pre-fill the text area with the e-mail template text. The user is presented with the option of entering a new subject for the e-mail and new text. The user is also presented with a send button (not shown). Also, on the same page there is a history of e-mails sent. The table will have a re-send button, for example, at the right of each row. If the user clicks on a table row, the fields of the e-mail section will be populated with the date of the e-mail previously sent.

Referring to FIG. 2, when the user is presented with the Account Detail page of FIG. 6, the user has the Audit Trail Field 602. The user may. accordingly, proceed to step 226 and view the audit trail for the particular account.

It is to be understood that the present invention is described above in reference to specific embodiments, which are for purposes of example only, and that the invention is not limited to the specific arrangement, or configuration described hereinabove or shown in the drawings, but also comprises the various modifications readily apparent to one skilled in the art upon reading this specification, as defined by the broadest scope of the appended claims.

What is claimed is:

1. A method for posting offerings for goods and services and for receiving and negotiating responses, comprising:
receiving a plurality of offer data records at a database, from one or more seller computers remote from said database, each having a descriptor data field identifying a commodity and an identify of an offeror;
storing said plurality of offer data records into said database;
initializing to a first state a status flag data associated with each of said plurality of offer data records;
receiving at said database an inquiry from a buyer computer remote from said database, said inquiry having a search field corresponding to at least a portion of said descriptor data field;
selecting one or more of said offer data records from said database based on said search field;
transmitting said selected one or more offer data records, and said status flag associated with the each of the selected one or more data records, to said buyer computer;
receiving at said database a purchase order data record from said buyer computer, said purchase order data record identifying a buyer and a particular offer data record from said one or more selected offer data records, and having a purchase offer field identifying one or more terms of an offer for purchase of the commodity identified by the descriptor field of said particular offer data record;
storing said purchase order data record in said database;
transmitting a purchase order received data to the offeror identified by the descriptor field of said particular offer data record, said purchase order received data identifying said buyer, identifying an offer of sale corresponding to said particular offer data record, and identifying said one or terms of an offer for purchase;
receiving at said database a seller response data from said offeror, said seller response data having an acceptance field reflecting acceptance of, rejection of, or a counter-offer to said one or more terms of an offer for purchase;
storing said seller response data in said database;
transmitting to said buyer a seller response received data, said seller response received data identifying contents of the acceptance field of said seller response data;
receiving at said database a committed purchase order data from said buyer; and
changing to a second state the status flag data associated with said particular offer data record.
